(19) United States
(12) Patent Application Publication
(10) Pub. No.: US 2017/0371373 A1
(43) Pub. Date: Dec. 28, 2017

(54) A DEVICE CAPABLE OF BEING OPERATED IN DIFFERENT MODES

(71) Applicant: Douglas MORSE, Houghton (GB)

(72) Inventor: Douglas MORSE, Houghton (GB)

(21) Appl. No.: 15/537,066

(22) PCT Filed: Dec. 3, 2015
(86) PCT No.: PCT/GB2015/053709

§ 371 Date: Jun. 16, 2017

(30) Foreign Application Priority Data
Dec. 16, 2014 (GB) 1422392.9

(51) Int. Cl. G06F 1/16; G06F 13/38; G06F 13/12

(52) U.S. Cl. CPC G06F 1/1632; G06F 13/122; G06F 13/387

(57) ABSTRACT

A computing device may have a number of ports that can be connected to different peripheral devices and the availability, capability and/or functionality available through different ports may change depending on a mode of operation of the computing device. A user will not generally be aware of which ports can be used as they are all, in theory, available and the usability of an individual port is likely to change if a different host device is connected to the docking station or according to the mode the computing device is operating in. This is especially the case if the ports can all accept the same plug, for example, a USB Type-C plug. In order to allow a user to see easily which port is/are active to provide a particular capability, a controller determines a mode of operation of the device, the mode of operation being such that particular capabilities are made available at one or more of the plurality of peripheral ports, and controls an indicator associated with a particular peripheral port to provide an indication that the particular peripheral port is active to provide a capability if a peripheral device requiring that capability is connected to the particular peripheral port.

### FIELD OF THE INVENTION

The present invention relates to a device and method for indicating capabilities of peripheral ports that can provide different capabilities to peripheral devices depending on a mode of operation.

### BACKGROUND

The Type-C connection currently being developed by USB-IF can be used in a number of alternate modes. This means that a computer, laptop or other host device has control over which capabilities of the Type-C connector and cable it is able to use. This is especially important where the host device is attached via a Type-C cable to a docking station, adapter or similar device that allows the host device to be connected to one or more peripherals. Such a docking station may have a number of ports to which different peripherals may be connected. Each port has a separate function (audio, video etc.) and an individual docking station may be able to provide full functionality through each peripheral port. However, depending on which mode is being used by the host device, particular ports may or may not be used so that a subset of the ports may not be active.

In some cases, a computing device itself may have a number of ports that can be connected to different peripheral devices and the availability, capability and/or functionality available through different ports may change depending on a mode of operation of the computing device. For example, the computing device may have different levels of security and the computing device may change modes of operation according to a user that is allowed to use the computing device at a particular security level.

Thus, for example, ports that allow data exchange may be controlled to be inactive, or to only allow reception or transmission of data, or to limit the speed of data transmission or reception. Video ports may be limited to only particular types of video or particular video quality.

A user will not generally be aware of which ports can be used as they are all, in theory, available and the usability of an individual port is likely to change if a different host device is connected to the docking station or according to the mode the computing device is operating in. This will result in frustration and wasted time for the user as he or she is likely to attempt to connect a peripheral to a port that is not supported and will then be unsure whether it is not supported or simply not working.

The present invention attempts to overcome or at least mitigate this problem.

### SUMMARY OF THE INVENTION

According to a first aspect, the invention provides a device comprising:

a host port for connection to a host computer device;

a plurality of peripheral ports for connection to one or more peripheral devices;

a controller for determining a mode of operation of the host computer device, when the host computer device is connected to the host port, the mode of operation being such that particular capabilities are made available at one or more of the plurality of peripheral ports; and

at least one indicator associated with a particular peripheral port of the plurality of peripheral ports and being controlled by the controller to provide an indication to a user that the particular peripheral port is active to provide a capability if a peripheral device requiring that capability is connected to the particular peripheral port.

The device may be a docking station. The host port may be a USB Type-C port.

According to a second aspect, the invention provides a device comprising:

a plurality of peripheral ports for connection to one or more peripheral devices;

a controller for determining a mode of operation of the device, the mode of operation being such that particular capabilities are made available at one or more of the plurality of peripheral ports; and

at least one indicator associated with a particular peripheral port of the plurality of peripheral ports and being controlled by the controller to provide an indication to a user that the particular peripheral port is active to provide a capability if a peripheral device requiring that capability is connected to the particular peripheral port.

According to a third aspect, the invention provides a method for indicating whether a capability is available at a particular peripheral port of a plurality of peripheral ports on a device, the method comprising:

connecting a host computing device to the device;

negotiating with the host computing device a mode of operation of the host computing device and which particular capabilities are made available at one or more of a plurality of peripheral ports of the device;

controlling at least one indicator associated with a particular peripheral port of the plurality of peripheral ports to provide an indication to a user that the particular peripheral port is active to provide a capability if a peripheral device requiring that capability is connected to the particular peripheral port.

The indication may be a visual indication or an aural indication.

The visual indication may comprise one or more LEDs or a shutter that blocks access to the particular peripheral port.

The indication may indicate a level of the capability that is available from the particular peripheral port, for example, a level of quality of the capability. This will add information for the user, especially in a case where there are, for example, multiple video ports with different capabilities: the user may wish to use the one with the highest quality.

The indication may be controlled to provide a constant indication, which would make it quicker for the user to check whether or not a port is functional. It would also be more convenient as no action by the user is necessary. Alternatively, the indication may be controlled to provide the indication when prompted by user behaviour. For example, an LED associated with a given port could flash when the user plugs in a cable. This could result in less wasted energy and less need for processing and continual notification of functionality, depending on the method of indication chosen; the capabilities of the host would only need to be known when the user prompts the dock to give an indication. This may also result in an option for non-visual indications that would otherwise be impractical.

The present device and method provides a way for the user to find out whether or not a specific port can be used without having to experiment. This is advantageous as it will result in less wasted time and frustration for the user and also less worry about whether or not the device, dock or peripheral in question is, in fact, faulty. As a result, it may also lead to less waste as it will be clear that no part of the system is faulty and in need of replacement.

It should be pointed out that capability is an attribute of a host at a particular point in time, indicating whether it is able to provide output or receive input of a particular type, the property of capability then being transferred to the port providing the output or receiving the input. It may change even within the life of a connection (e.g. to a docking station) depending on changes to the settings of the host, such as if the host enters a different alternate mode. It is distinct from the status of a connection or port, which indicates whether input or output through that connection or port is ever possible and whether such a transfer is currently occurring. For example, a computing device may have an output interface that produces video output in a particular format, but be in a mode meaning that such output is not available. An indication of status would return ‘true’—the output interface exists—while an indication of capability returns ‘false’—the computing device is not currently in a mode where it can produce such output.

### BRIEF DESCRIPTION OF THE DRAWINGS

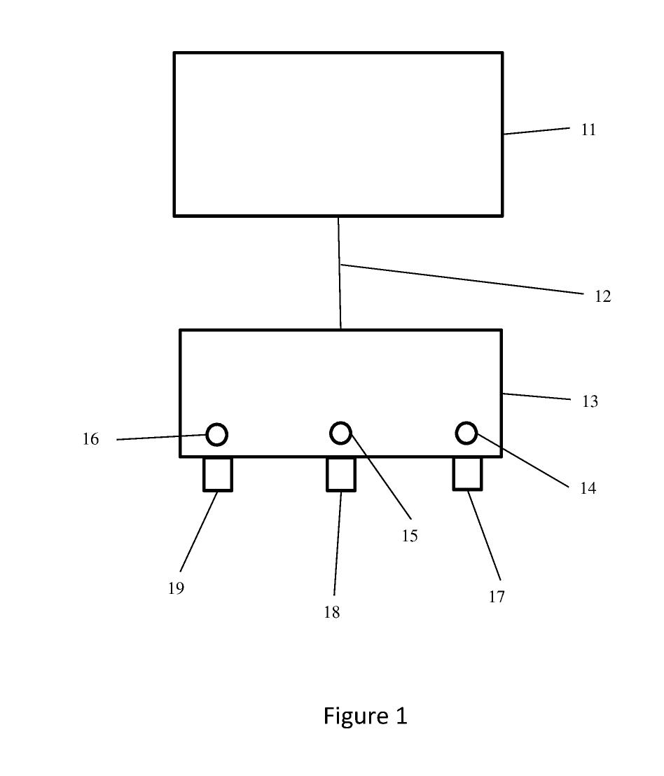

An embodiment of the present invention will now be more fully described, solely by way of example, with reference to FIG. 1.

### DETAILED DESCRIPTION OF THE DRAWINGS

It will be appreciated that the embodiment to be described is purely an example and the details of its implementation do not in any way limit the invention, which is defined by the claims.

Thus, FIG. 1 shows a host Computer [11] connected to a Dock [13] via a USB Type-C cable [12]. The Dock has three ports [17, 18, 19] which have various capabilities: data (suitable for connection to an external hard drive) [17], HDMI [18], and VGA (both of which are suitable for additional monitors) [19]. Each port [17, 18, 19] has a corresponding LED [14, 15, 16] associated therewith. These LEDs provide a visual indication of which port or ports is/are functional. It will, of course, be appreciated that further ports may be available, for example audio ports. However, for ease of description, they are not shown.

In this embodiment, the Computer [11] is arranged so that it does not supply HDMI-format display data. When the Type-C cable [12] is plugged into the Computer [11] and Dock [13], the Dock [13] communicates with the Computer [11] to determine whether the Computer [11] is operable to supply appropriate signals to each of the ports [17, 18, 19]. For example, the Dock [13] may send a separate signal for each port, enquiring whether signal are likely to be made available for that port. In this mode of operation, the Computer [11] returns ACK messages to the signals enquiring about data and VGA, but a NAK message to the signal enquiring about HDMI. This indicates to the Dock [13] that the Computer [11] is able to supply data and VGA signals, but not HDMI. The HDMI port [18] will therefore be non-functional.

In this embodiment, the indication of the capability of the each port is the colour of the LED [14, 15, 16] associated with each port [17, 18, 19]. Since the data and VGA ports [17, 19] are functional with the Computer [11] in the current mode of operation, the associated LEDs [14, 16] are green. However, because the HDMI port [18] is not functional, the associated LED [15] is red.

This provides the user with the information that data and VGA display signals are available at the data and VGA ports [17, 19], and that the HDMI port [18] is inactive. Therefore, the user will not waste time attempting to connect a display to the HDMI port [18], but will immediately connect an appropriate VGA display to the VGA port [19].

The above example embodiment assumes that the indication is a binary system (red means that there is no functionality, green means that there is functionality) and that the indication is constantly present as the LEDs are on all the time. Of course, it is possible for there to be a single colour LED (green or red or other colour) which would simply indicate that there is or is not functionality at the particular port, with the absence of the LED light indicating the opposite.

In an alternative embodiment, there might be different-coloured LEDs for different levels of functionality. For example, in the case of a video port, there might be a red LED to indicate that no video data is available from that port, a green LED to indicate that there is video data available and a blue LED to indicate that the video data is of HD quality.

In a second alternative embodiment, the LEDs might not be lit constantly. Instead, they might flash when the Dock is connected to the Computer, or an individual LED might flash when the user plugs a cable into the socket in question.

Other embodiments might use indications other than LEDs. For example, the Dock might beep when a cable is plugged into a port to indicate that there is in fact no functionality available through that port. In another example, the Computer might display a message when the cable is plugged in.

In a further embodiment, the indication might take the form of a physical barrier. For example, when, during negotiation, the Dock discovers that the Computer will not supply data through a specific port, it might lower a shutter over that port's socket to prevent the user from plugging in a cable and indicating to him or her that that port will not work.

Although only one particular embodiment has been described in detail above, it will be appreciated that various changes, modifications and improvements can be made by a person skilled in the art without departing from the scope of the present invention as defined in the claims. For example, hardware aspects may be implemented as software where appropriate and vice versa. Furthermore, although the particular embodiment has been described in the context of the host Computer being coupled to a Dock, it will be appreciated that the host Computer could, itself, have the Dock functionality in that it may have a plurality of ports for connection to peripherals, and those ports may have different availability, capability and/or functionality depending on a mode of operation of the Computer. In this case, the Computer itself could have the indicator(s) available to indicate to a user which port(s) is/are active and/or has/have particular capability/ies.

1. A device comprising:
a host port for connection to a host computer device;
a plurality of peripheral ports for connection to one or more peripheral devices;
a controller for determining a mode of operation of the host computer device, when the host computer device is connected to the host port, the mode of operation being such that particular capabilities are made available at one or more of the plurality of peripheral ports; and
at least one indicator associated with a particular peripheral port of the plurality of peripheral ports and being controlled by the controller to provide an indication to a user that the particular peripheral port is active to provide a capability if a peripheral device requiring that capability is connected to the particular peripheral port.

2. A device according to claim 1, wherein the device is a docking station.

3. A device according to claim 1, wherein the host port is a USB Type-C port.

4. A device comprising:
a plurality of peripheral ports for connection to one or more peripheral devices;
a controller for determining a mode of operation of the device, the mode of operation being such that particular capabilities are made available at one or more of the plurality of peripheral ports; and
at least one indicator associated with a particular peripheral port of the plurality of peripheral ports and being controlled by the controller to provide an indication to a user that the particular peripheral port is active to provide a capability if a peripheral device requiring that capability is connected to the particular peripheral port.

5. A device according to claim 1, wherein the at least one indicator comprises a visual indicator.

6. A device according to claim 5, wherein the visual indicator comprises one or more Light Emitting Diodes (LEDs).

7. A device according to claim 5, wherein the visual indicator comprises a shutter that blocks access to the particular peripheral port.

8. A device according to claim 1, wherein the at least one indicator is an aural indicator indicating whether the capability is available when a peripheral device is connected to the particular peripheral port.

9. A device according to claim 1, wherein the at least one indicator indicates a level of the capability that is available from the particular peripheral port.

10. A device according to claim 9, wherein the level of the capability comprises a level of quality of the capability that is available from the particular peripheral port.

11. A device according to claim 1, wherein the controller controls the indicator to provide a constant indication.

12. A device according to claim 1, wherein the controller controls the indicator to provide the indication when prompted by user behavior.

13. A method for indicating whether a capability is available at a particular peripheral port of a plurality of peripheral ports on a device, the method comprising:
connecting a host computing device to the device;
negotiating with the host computing device a mode of operation of the host computing device and which particular capabilities are made available at one or more of a plurality of peripheral ports of the device;
controlling at least one indicator associated with a particular peripheral port of the plurality of peripheral ports to provide an indication to a user that the particular peripheral port is active to provide a capability if a peripheral device requiring that capability is connected to the particular peripheral port.

14. A method according to claim 13, wherein the indication comprises a visual indication.

15. A method according to claim 13, wherein the indication comprises an aural indication.

16. A method according to claim 13, wherein the indication indicates a level of the capability that is available from the particular peripheral port.

17. A method according to claim 16, wherein the level of the capability comprises a level of quality of the capability that is available from the particular peripheral port.

18. A method according to claim 13, wherein the indicator is controlled to provide a constant indication.

19. A method according to claim 13, wherein the indicator is controlled to provide the indication when prompted by user behavior.

20. A device according to claim 4, wherein the at least one indicator comprises a visual indicator.

21. A device according to claim 20, wherein the visual indicator comprises one or more LEDs.

22. A device according to claim 20, wherein the visual indicator comprises a shutter that blocks access to the particular peripheral port.

23. A device according to claim 4, wherein the at least one indicator is an aural indicator indicating whether the capability is available when a peripheral device is connected to the particular peripheral port.

24. A device according to claim 4, wherein the at least one indicator indicates a level of the capability that is available from the particular peripheral port.

25. A device according to claim 24, wherein the level of the capability comprises a level of quality of the capability that is available from the particular peripheral port.

26. A device according to claim 4, wherein the controller controls the indicator to provide a constant indication.

27. A device according to claim 4, wherein the controller controls the indicator to provide the indication when prompted by user behavior.
